(19) United States
(12) Patent Application Publication
(10) Pub. No.: US 2011/0014588 A1
(43) Pub. Date: Jan. 20, 2011

(54) APPARATUS FOR ANCHORING A DENTAL APPLIANCE

(76) Inventors: Bruce Seavey, North Attleboro, MA (US); James Ellison, Johnston, RI (US)

Correspondence Address: PATTON BOGGS LLP, 2550 M STREET NW, WASHINGTON, DC, 20037-1350, US

(21) Appl. No.: 12/505,103

(22) Filed: Jul. 17, 2009

(51) Int. Cl. A61C 8/00

(52) U.S. Cl. 433/174

(57) ABSTRACT

A dental appliance anchoring apparatus including an implant anchor member having a tapered threaded post for engagement with a bone and a female receptacle, the female receptacle having a lateral undercut reservoir for accepting an adhesive, wherein the threaded post includes threads that have a substantially flat top land; and an angled support having a slotted tubular base and an upper angled female eyelet for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the implant anchor member, wherein the angled support is rotatable within the female receptacle for optimizing its position prior to being secured with the adhesive.

### BACKGROUND

Without limiting the scope of the invention, its background will be described in relation to an apparatus for anchoring a dental apparatus, as an example.

Various methods and structures for anchoring appliances in the oral cavity are known in the art. For example, U.S. Pat. No. 4,540,367, issued to Sulc, (“the '367 Sulc patent”) describes a multi-piece apparatus having a female member which attaches to a surface of a tooth adjacent to an apparatus anchoring site. Also shown in the '367 Sulc patent is an oral appliance containing a male member which attaches to the female member. The apparatus and method described by the '367 Sulc patent, although particularly useful for attaching to a dental surface adjacent to a desired anchoring site, is not optimal for all anchoring requirements.

In another patent issued to Sulc, U.S. Pat. No. 5,195,891 (“the '891 patent”), it describes a multi-piece endosteal implant system for mounting one or more dental implants. It includes a threaded base portion that is secured into the jaw bone of a patient. An angled support has an axially quartered male end for inserting into the threaded base portion and a female end for accepting a dental prosthesis. The female end terminates distally in a lateral planar end cut substantially perpendicular with the upper angled portion of the female end.

Another anchoring method and apparatus is described by U.S. Pat. No. 5,749,732, issued to Sendax (“the Sendax patent”). The apparatus described by the Sendax patent comprises a threaded anchor post having a square male upper extension. Using a wrench having a square socket, the threaded portion is rotated to attain threaded engagement with a bone. After the threaded portion has penetrated the bone to a suitable depth the square male upper extension remains above the gum. The threaded post portion has a lower threaded portion and an upper threaded portion separated by an unthreaded land. The Sendax patent describes the unthreaded land as functioning to assist bone growth engagement, thereby securing the anchor from unthreading. The square upper extension mates with, and is secured by adhesive to an oral appliance having a corresponding square receptacle. There are commercially available anchors similar to the device described by Sendax but without the unthreaded land.

Various methods and apparati for adjusting the angle of a dental appliance anchor are known. For example, U.S. Pat. No. 4,713,04, issued to Linkow et. al (“Linkow”) discloses an implant placed in the bone and rotated into a proper orientation. Linkow shows a wedge shaped collar having an angled upper surface, which is described as positioned to coincide with the angle of the shaft so that the free end of the shaft extends perpendicularly from the angled surface. Linkow further shows a prosthetic tooth anchor threaded onto the free end of the shaft, to secure the collar in a fixed orientation. The Linkow apparatus and method, although directed to an alignment issue, is relatively complex and may have insufficient structural rigidity for some applications.

### SUMMARY

The above-described problems are solved and a technical advance is achieved by the apparatus for anchoring a dental appliance (“dental appliance anchoring apparatus”) disclosed in this application. In one embodiment, the dental appliance anchoring apparatus includes an implant anchor member having a tapered threaded post for engagement with a bone and a female receptacle, the outside area of the female receptacle having gripping portions for engaging with a tightening device, the female receptacle having a lateral undercut reservoir for accepting an adhesive, wherein the threaded post includes threads that have a substantially flat top land; and an angled support having a slotted tubular base and an upper angled female eyelet for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the implant anchor member, wherein the angled support is rotatable within the female receptacle for optimizing its position prior to being secured with the adhesive.

In one aspect, the upper angled female eyelet may be formed by an outer sidewall that terminates radially inwardly towards the center of the upper angled female cyclct. In another aspect, the upper angled female eyelet may be formed by an inner sidewall that terminates radially outwardly towards the outer sidewall. Further, the upper angled female eyelet may terminate distally in a curved annular edge. Also, the slotted tubular base may include one or more slotted tubular sections forming a hollowed cylindrical area disposed therebetween. In yet another aspect, the one or more slotted tubular sections comprises curved planar portions that extend distally from the outer circumference of the angled support. Additionally, the implant anchor member may be a unitary metal structure. The appliance anchoring apparatus may further include a dental prosthesis having a male extension shaped for cooperative engagement with the upper angled female eyelet of the angled support, wherein the dental prosthesis is secured to the angled support by such cooperative engagement. The slotted tubular base of the angled support may be secured within the female receptacle of the implant anchor member by a combination of an interference fit in resilient engagement with the slotted lower circular base and the adhesive.

In another embodiment, the dental appliance anchoring apparatus includes an elongated body for engagement with a bone, the elongate body having a female threaded receptacle; a base having a male threaded portion and a female receptacle, the female receptacle having a lateral undercut reservoir for accepting an adhesive, wherein the male threaded portion threads into the female threaded receptacle; and an angled support having a slotted tubular base and an upper angled female eyelet terminating distally in a curved annular end for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the base by the adhesive, and wherein the slotted tubular base of the angled support and the upper receptacle are constructed and arranged such that the lower base of the angled support rotates within the upper receptacle, about the first longitudinal axis, prior to being secured by the adhesive.

In one aspect, the curved annular end is formed by an outer sidewall that terminates radially inwardly towards the center of the upper angled female eyelet. In another aspect, the curved annular end is formed by an inner sidewall that terminates radially outwardly towards the outer sidewall. Additionally, the slotted tubular base may include one or more slotted tubular sections forming a hollowed cylindrical area disposed therebetween. Also, the one or more slotted tubular sections comprises curved planar portions that extend distally in a longitudinal direction from the outer circumference of the angled support. Further, the elongated body is a unitary metal structure. In still another aspect, the dental appliance anchoring apparatus may include a dental prosthesis having a male extension shaped for cooperative engagement with the upper angled female eyelet of the angled support, wherein the dental prosthesis is secured to the angled support by such cooperative engagement. Preferably, the slotted tubular base has a wall thickness of from about 0.01 inches to about 0.03 inches. Also preferably, the slotted tubular base may include a longitudinal tube with four equally spaced longitudinal slots, the slots having a diameter of from about 0.011 inches to 0.015 inches. Additionally, the female receptacle may include a circumferential ridge and the slotted tubular base may include a circumferential recess for engaging with the circumferential ridge of the female receptacle.

In yet another embodiment, the invention includes an angled dental support including a slotted tubular base for engaging a dental implant anchor; and an upper angled female eyelet terminating distally in a curved annular end for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the implant anchor member by the adhesive, and wherein the slotted tubular base of the angled support and the upper receptacle are constructed and arranged such that the lower base of the angled support rotates within the upper receptacle, about the first longitudinal axis, prior to being secured by the adhesive.

In one aspect, the curved annular end forms a substantially rounded annular end. In another aspect, the curved annular end is substantially rounded. In still another aspect, the slotted tubular base includes one or more slotted tubular sections forming a hollowed cylindrical area disposed therebetween. Additionally, the one or more slotted tubular sections includes curved planar portions that extend distally longitudinally from the outer circumference of the angled support. Also, the angled dental support may further include a dental prosthesis having a male extension shaped for cooperative engagement with the upper angled female eyelet of the angled dental support, wherein the dental prosthesis is secured to the angled support by such cooperative engagement. The slotted tubular base may include one or more slotted tubular sections forming a hollowed cylindrical area disposed therebetween.

### BRIEF DESCRIPTION OF THE DRAWINGS

For a more complete understanding of the features and advantages of the dental appliance anchoring apparatus, reference is now made to the detailed description of the invention along with the accompanying figures in which corresponding numerals in the different figures refer to corresponding parts and in which:

FIG. 1 is an illustration of a side view of an assembled dental appliance anchoring apparatus according to one embodiment;

FIG. 2 is an illustration of a top view of the assembled dental appliance anchoring apparatus of FIG. 1 according to one embodiment;

FIG. 3 is an illustration of a side view of an implant anchor member of the dental appliance anchoring apparatus of FIG. 1, prior to assembly according to one embodiment;

FIG. 4 is an illustration of a cut-away enlarged view of the female circular receptacle and portion of the threaded shaft of the dental appliance anchoring apparatus of FIG. 3, seen from cut line “4-4” of FIG. 3 according to one embodiment;

FIG. 5 is an illustration of a side view of an angled support of the dental appliance anchoring apparatus of FIG. 1 according to one embodiment;

FIG. 6 is an illustration of a perspective view of the angled support of the dental appliance anchoring apparatus of FIG. 5 detailing its slotted tubular base according to one embodiment;

FIG. 7 is an illustration of a bottom view of the angled support of the dental appliance anchoring apparatus of FIG. 5 detailing its slotted tubular base according to one embodiment;

FIG. 8 is an illustration of a cross-sectional view of the angled support of the dental appliance anchoring apparatus of FIG. 5, seen from the cut line “8-8” of FIG. 7 according to another embodiment;

FIG. 9 is an illustration of an enlarged view of the slotted cylindrical portion of the angled support of the dental appliance anchoring apparatus labeled “9” in FIG. 8 according to one embodiment;

FIG. 10 is an illustration of an enlarged view of the rounded end of the angled support of the dental appliance anchoring apparatus labeled “10” in FIG. 8 according to one embodiment;

FIG. 11 is an illustration of an enlarged view of a portion of the female circular receptacle labeled “11” in FIG. 1 of the implant anchor member of the dental appliance anchoring apparatus of FIG. 1 according to one embodiment;

FIG. 12 is an illustration of an enlarged view of the threaded shaft of the implant anchor member of the dental appliance anchoring apparatus according to one embodiment; and

FIG. 13 is an exploded view of an assembled dental appliance anchoring apparatus with an angled support according to another embodiment.

### DETAILED DESCRIPTION OF THE DRAWINGS

The term “exemplary” is used herein to mean “serving as an example, instance, or illustration.” Any embodiment, aspect, or design described herein as “exemplary” is not necessarily to be construed as preferred or advantageous over other embodiments, aspects, or designs.

Additionally, terms such as “above,” “below,” “upper,” “lower,” etc., are used for convenience in referring to the accompanied drawings. In general, “above,” “upper,” “upward” and similar terms refer to a direction that is commonly thought of as vertically upward and the terms “below,” “lower,” and “downward” and similar terms refer to a direction in the opposite direction or vertically downward as commonly known. For purposes of this discussion, the relativity of these terms may be thought of in the context of the use and operation of the present dental appliance anchoring apparatus. In one embodiment, the term “lower” may refer to the lower end of dental appliance anchoring apparatus or angled support, and the term “upper” may refer to the upper end of dental appliance anchoring apparatus or angled support, for example.

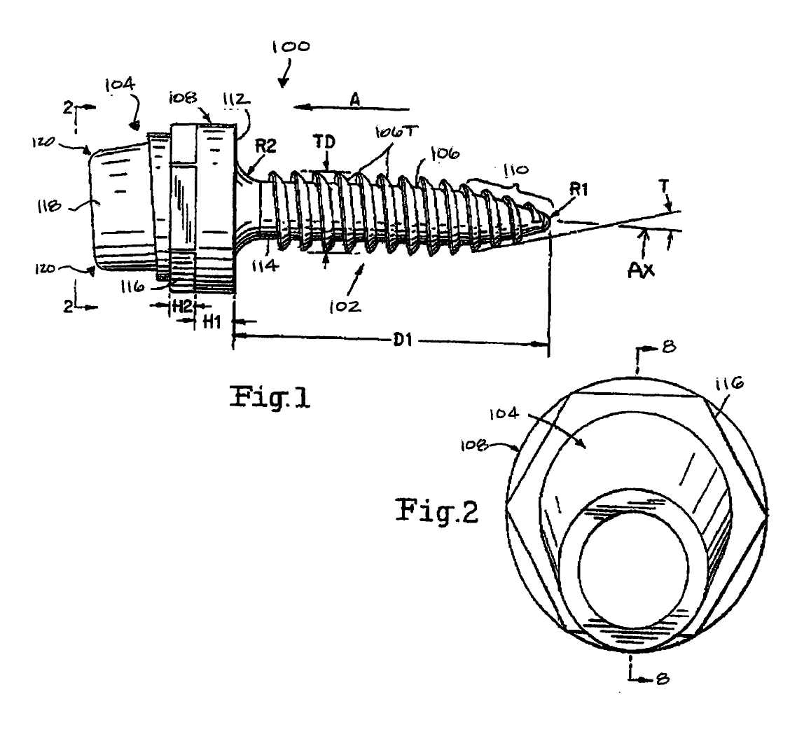

As an overview, an example dental appliance anchoring apparatus according to a first embodiment will be described with reference to FIGS. 1-12. FIG. 1 shows one variation of a dental appliance anchoring apparatus 100 after assembly in an oral cavity as described herein. FIGS. 1-12 show examples of, and are used for description of, one or both of the two major components of the dental appliance anchoring apparatus as shown in FIG. 1, notably an implant anchor member 102 and an angled support 104. The relative position labels of “above” and below are in reference to the “A” direction line shown in FIG. 1, with an item “above” another item meaning the former to have a position further in the “A” direction.

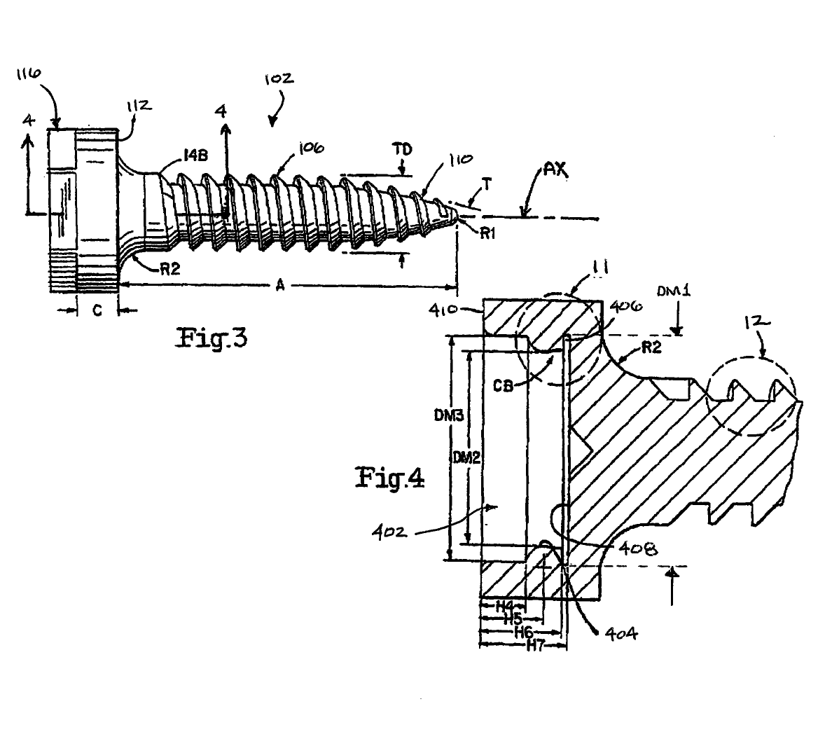

Referring now to FIGS. 1-3, they show a dental appliance anchoring apparatus 100 including implant anchor member 102 and angled support 104 according to one embodiment. Implant anchor member 102 includes a threaded shaft 106 and a receptacle base 108, which are described in greater detail with reference to FIGS. 3-4. Additionally, angled support 104 extends distally and ends in a upper angled female eyelet 118 having a radiused upper portion 120 as described further below. Dental appliance anchoring apparatus 100 is assembled as it is installed in an oral cavity, as further described below. After installation, implant anchor member 102 may be substantially below the gum line (not shown) of a patient, with threaded shaft 106 threaded into an underlying bone. Implant anchor member 102 may be a unitary metal structure, preferably formed of a metal, composite, or allow, such as titanium-aluminum-vanadium alloy, having threaded shaft 106 and receptacle base 108. Preferably, threaded shaft 106 has an outer thread diameter, labeled “TD,” and it has a tapered end 110; the tapered end having, for example, a taper angle of T degrees blending to a radius R1, for example. Example values for these dimensions are TD is approximately 2.21 millimeters; R1 is approximately 0.25 millimeters; and T is approximately 12 degrees. The taper T and radius R1 are for improved self-threading and implant into a bone of a patient. Threaded shaft 106 extends a distance D1 from a lower surface 112 of receptacle base 108. Preferably, for purposes of strength, a radius R2 merges a base 114 of threaded shaft 106 to lower surface 112. Example values are D1 is approximately 10, 13, or 15 millimeters, and R2 is approximately 0.75 millimeters.

As shown in FIG. 1, receptacle base 108 of implant anchor member 102 has a first height H1 in the “A” direction, and may have a gripping surface 116 formed on an outside upper portion for a second height H2. Example values are H1 is approximately 1.22 millimeters; and H2 is approximately 0.77 millimeters. As will be described below, gripping surface 116 is for a wrench (not shown) to engage and apply rotation to the implant anchor member, for threading it into a bone of a patient. FIG. 3 shows a side view of an example implant anchor member 102 before connection or insertion of angled support 104.

As seen in FIG. 2, gripping portion 116 of angled support 104 has a hexagonal shape, for example. Other shapes contemplated by the invention include, but are not limited to, square, two-sided, and pentagonal as would be easily understood by one skilled in the art.

Referring now to FIG. 4, it shows a cross-sectional view of receptacle base 108 section of implant anchor member 104 of FIGS. 1 and 3 and a portion of threaded shaft 106, seen from the cut-line “4-4” of FIG. 3. Formed within receptacle base 108 is a female receptacle 402 for accepting and supporting angled support 104. Female receptacle 402 is preferably a circular receptacle having a major depth DP1 and a ridge 404 spaced by an undercut 406 from the bottom surface 408.

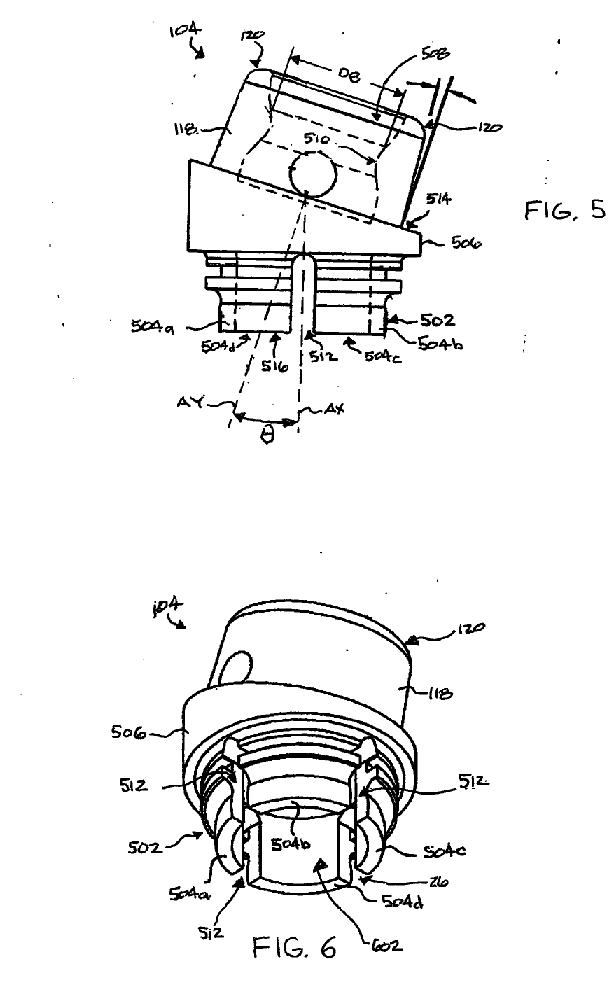

As will be understood from the description below, undercut 406 functions as a reservoir for adhesive that is used during the assembly operation. As will also be understood, the function of female receptacle 402 is to accommodate, and secure from axial movement during positioning, a slotted tubular base 502 (FIGS. 5-6) of angled support 104, while allowing temporary rotation of slotted tubular base 502 about its axis AX. For these and other reasons, it will be understood that the specific form and dimension of ridge 404 and undercut 406 is dictated, in part, by the form and dimension of slotted tubular base 502.

Referring to FIG. 4 and FIG. 11, where FIG. 11 shows a detailed view of a portion of FIG. 4 labeled area “11,” the female receptacle 402 has an undercut 406 extending from the lowermost surface of female receptacle 402, labeled 408, to a point H3 below the upper surface 410. The diameter of the undercut 406 is labeled DM1. Ridge 404 preferably has a radius R4 and a cut-back CB. As will be understood from FIGS. 5-8 described herein, the cut-back CB permits the slotted tubular sections 504a-504d (collectively 504) to expand and, thus, lock into engagement with female receptacle 402.

Radius R4 begins at a height H4 below the upper surface 410 and ends at point H5, with the cut-back CB extending down to H6. The inner diameter DM2 formed by the ridge 404 is for an interference fit with slotted tubular base 502 of angled support 104, as described in greater detail below. The interference fit is preferably firm, yet permits rotation of upper angled female eyelet 118 about the axis AX prior to the adhesive setting, as described below.

Therefore, the inner diameter DM2 is preferably held to a close tolerance, such as, for example, plus or minus 0.005 millimeters. Above ridge 404 is a larger circular opening, having a diameter DM3, with a radius R5 at its opening to facilitate insertion of the slotted tubular base 502.

Example values for the above-identified dimensions are DP1 is approximately 1.49 millimeters; DM1 is approximately 3.56 millimeters, with an example tolerance of plus or minus 0.025 millimeters; DM2 is approximately 2.97 millimeters, with an example tolerance of plus or minus 0.005 millimeters; R4 is approximately 0.307 to 1.05 millimeters; F is approximately 0.25 millimeters; R5 is approximately 0.15 millimeters; H3 is approximately 0.77 millimeters, with an example tolerance of plus or minus 0.005 millimeters; H4 is approximately 1.07 millimeters; H5 is approximately 1.36 millimeters; and H6 is approximately 1.48 millimeters.

FIG. 12 shows an enlargement of the threads 106T within the region of FIG. 4 labeled “12.” As seen from FIG. 12, the threads 106T preferably have a substantially flat top land TL, with a lower land TR that is angled by TA degrees, with a typical TA value being 45 degrees.

It will be understood that the example female receptacle 402 described above is for purposes of explaining the operation of, and providing general guidance in the practicing of dental appliance anchoring apparatus 100. Upon reading this disclosure, other structures for female receptacle 402, which provide for rotation of the angled support 104 prior to setting of its adhesive can be readily identified by persons skilled in the art.

Referring now to FIGS. 5-8, they show angled support 104 including upper angled female eyelet 118. Angled support 104 includes slotted tubular base 502, a wedge mid-base 506, upper angled female eyelet 118. Upper angled female eyelet 118 includes a cavity 508 with a ridge 510. The inner diameter of ridge 510 is labeled D8. Cavity 508 and ridge 510, in accordance with the diameter D8, securely hold a dental prosthesis such that depicted by U.S. Pat. No. 5,195,181, issued to Sulc, (“Sulc '181”), and U.S. Pat. No. 4,540,367, issued to Sulc (“Sulc '367”), both of which are hereby incorporated by reference, by engagement with its male extension installed in a recess at the bottom of the prosthesis.

Slotted tubular base 502 of angled support 104 preferably has multiple slotted tubular sections 504, which can resiliently move in the radial direction R when slotted tubular base 502 is inserted into female receptacle 402 of implant anchor member 102, as described below. In one embodiment, four slotted tubular sections 504 are separated by slots 512. Preferably, slots 512 extend longitudinally through slotted tubular base 502.

Slotted tubular base 502 and wedge mid-base 506 are substantially circular about an axis AX. The upper surface 514 of wedge mid-base 506, as can be seen in FIG. 5, supports upper angled female eyelet 118 at an angle THETA (θ), which is measured between the axis AX and the axis AY of upper angled female eyelet 118. As described below, a method according to the present invention contemplates selection of the desired THETA angle at the time the described angled support 104 is installed into an oral cavity. Many angled support 104 may be manufactured with different predetermined angles to enable easy use during fitting operations. For example, some exemplary preferable sets of THETA angles include 0, 5, 11, and 17 degrees. This set, however, is not a limitation, as others may be identified and used by persons skilled in the art.

Slotted tubular base 502 includes one or more slotted tubular sections 504 that may be separated by slots 512. In one embodiment, each slotted tubular section 504 is a curved planar material, such as curved-wall or tubular portions, that extend distally from substantially the lower portion of wedge mid-base 506 and they terminate at their distal end 516. Slotted tubular base 502 is shown in FIGS. 5-8 having four slotted tubular sections 504, notably 504a-504d, that form and surround a hollowed area 602 of angled support 104. In one aspect, hollowed area 602 is a substantially cylindrical hollowed area disposed between slotted tubular sections 504. Slotted tubular sections 504 provide a rigid yet flexible means for snapping or connecting angled support 104 into female receptacle 402 of implant anchor member 102.

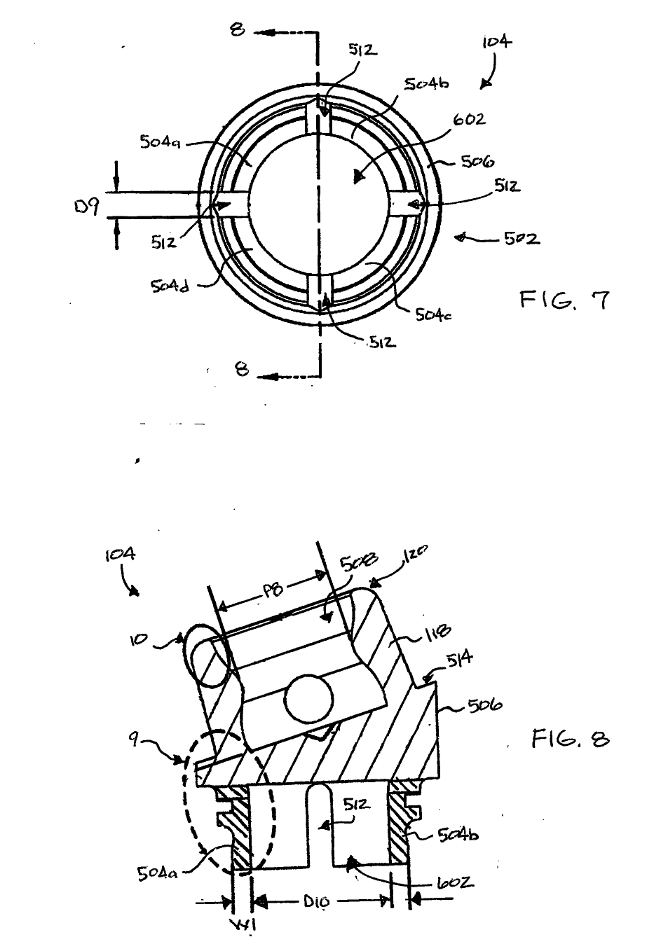

Referring now to FIG. 7, slots 512 may be equally spaced around slotted tubular base 502 to provide equally sized slotted tubular sections 504. The present slotted tubular base 502 may include any number of slots 512 and slotted tubular sections 504. Preferably, slotted tubular base 502 includes four slotted tubular sections 504 and four slots 512. In one aspect, slots 512 may have a diameter D9 of from about 0.008 inches to 0.018 inches, preferably, slots 512 may have a diameter D9 of approximately 0.013 inches.

As best seen in FIG. 8, each slotted tubular section 504 has a width W2 that may be preferably uniform substantially near distal end 516. Some exemplary widths W1 may be from about 0.01 inches to about 0.03 inches, preferably, width W1 may be approximately 0.02 inches. Preferably, a slot 512 is located between adjacent slotted tubular sections 504. Some exemplary widths W1 of slots 512 may be from about 0.005 inches to about 0.018 inches, preferably, the width W1 of slots 512 is approximately 0.013 inches. Additionally, the diameter D10 of hollowed area 602 may be from about 0.05 to about 0.09 inches, preferably, diameter D10 of hollowed area 602 is approximately 0.073 inches.

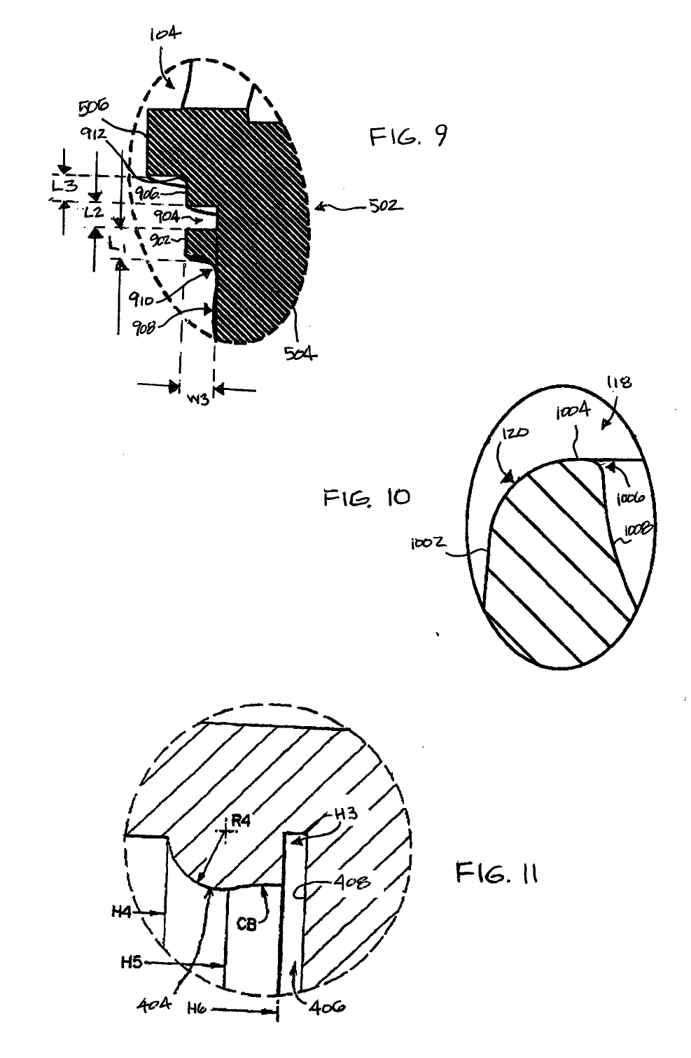

Referring no to FIG. 9, a portion of angled support 104 is shown in enlarged view. As shown in FIG. 8, FIG. 9 illustrates the portion of angled support 104 where slotted tubular base 502 and slotted tubular sections 504 transition to wedge mid-base 506, preferably. To ensure a snug fit between implant anchor member 102 and angled support 104, additional protrusions may extend radially outward from slotted tubular sections 504 and or slotted tubular base 502. In one aspect, a seat 902 is formed between a slot 904 and the outer sidewall of slotted tubular sections 504. Preferably, the width W3 between the outer sidewall of slotted tubular sections 504 and the outer edge of seat 902 is from about 0.004 inches to about 0.012 inches, preferably width W3 is approximately 0.008 inches. Additionally, the length L1 of seat 902 is from about 0.003 inches to about 0.008 inches, preferably, length L1 is approximately 0.005 inches. Also, the length L2 of slot 904 is from about 0.003 inches to about 0.009 inches, preferably, length L2 is approximately 0.006 inches. Slotted tubular base 502 may further have a portion between slot 904 and wedge mid-base 506, shown as portion 906, may have a length L3 of from about 0.004 inches to about 0.012 inches, preferably, length L3 is approximately 0.008 inches.

As seen in FIG. 9, slotted tubular base 502 may have an area of radius transition between the outer sidewall of slotted tubular sections 504 and seat 902, shown as radius portion 910. In one aspect, radius portion has a radius of from about 0.0082 inches to about 0.0102 inches, preferably, the radius portion has a radius of approximately 0.0092 inches. Radius portion 910 provides a notch or groove around slotted tubular base 502 for engaging with ridge 404 of implant anchor member 102. As further seen in FIG. 9, slotted tubular base 502 may have an area of radius transition between portion 906 and wedge mid-base 506, shown as radius portion 912. In one aspect radius portion 912 has a radius from about 0.003 inches to about 0.005 inches, preferably, radius portion 912 has a radius of approximately 0.004 inches.

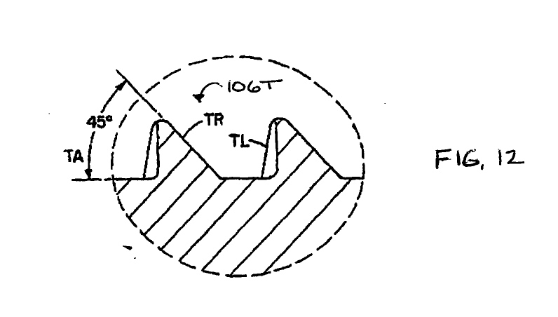

Referring now to FIG. 10, as described above, angled support 104 further includes upper angled female eyelet 118 that terminates distally in radiused upper portion 120. Radiused upper portion 120 presents a radiused or curved distal end to a dental prosthesis rather than a sharp edge as found in prior art apparatuses. Radiused upper portion 120 is a curved portion that transitions from an outer sidewall 1002 of upper angled female eyelet 118 to a distal end 1004 of upper angled female eyelet 118. In one aspect, the radius of radiused upper portion 120 may be from about 0.008 inches to about 0.012 inches, preferably, the radius of radiused upper portion 120 is approximately 0.010 inches. Further, the distal end of upper angled female eyelet 118 includes a second radiused upper portion 1006 that is a curved portion that transitions from an inner sidewall 1008 of upper angled female eyelet 118 to distal end 1004 of upper angled female eyelet 118. In one aspect, the radius of radiused upper portion 1006 may be from about 0.001 inches to about 0.003 inches, preferably, radius of radiused upper portion 1006 is 0.002 inches. Together, radiused upper portion 120 and radiused upper portion 1006 provide a curved annular edge at its distal end. Radiused upper portion 120 and radiused upper portion 1006 improves the acceptance of a male portion of a dental prosthesis made of a softer material without crushing the male portion.

A preferred material for angled support 104 is metal, composite, or alloy, such as a titanium alloy. Sulc '181 and Sulc '367 show a dental prosthesis having a male extension which is placed over and engaged into upper angled female eyelet 118.

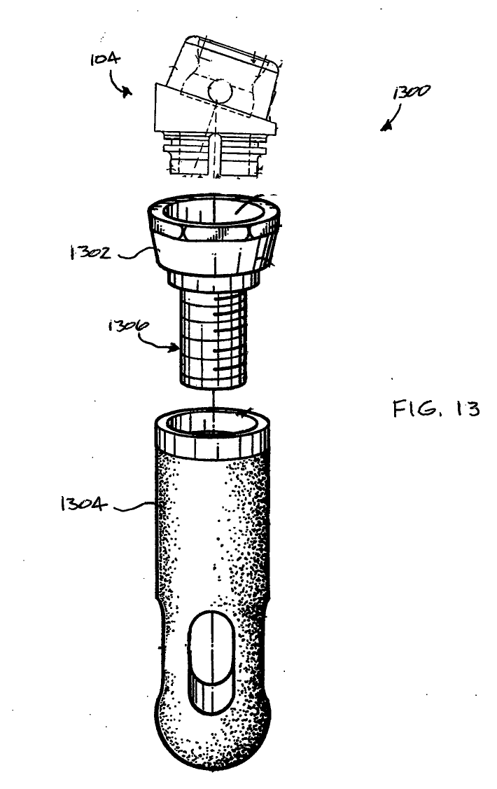

Referring now to FIG. 13, another embodiment of a dental appliance anchoring apparatus 1300 is shown. In this embodiment, angled support 104 is connected to a base 1302 having one or more of the similar or identical features of implant anchor member 102 as described herein, with a threaded portion 1306 replacing the threaded shaft 106. Dental appliance anchoring apparatus 1300 further includes an elongated body 1304 that secures into the underlying bone of a patient. Elongated body 1304 has female threaded portions that accept threaded portion 1306 of base 1302, such that they are threaded together when assembling the dental appliance anchoring apparatus 1300. In this embodiment, angled support 104 may be connected to base 1302 and secured in place with an adhesive as described herein. Then the assembled base 1302 and angled support 104 may then be threaded into elongated body 1304, such as with traditional implants. Additional disclosure relating to this embodiment may be found in U.S. Pat. No. 5,195,891 issued to Sulc, all of which is incorporated herein by reference.

As described in Sulc '181 and Sulc '367, the male extension within the dental prosthesis may be preferably formed of a plastic material having sufficient strength and durability to permit repeated connection and disconnection with upper angled female eyelet 118. In addition, the material of the male extension should develop a retaining friction between it and the material of upper angled female eyelet 118 to maintain attachment of the male extension and, accordingly, the attachment of the dental prosthesis to dental appliance anchoring apparatus 100. Further, the material of the extension should permit removal and reinsertion of the male cap when desired. This is preferred because the male extension typically absorbs wear due to time and chewing forces and, as a result, should be periodically replaced. An example material for the male extension is strong nylon. An example replacement technique by which one male cap is removed and replaced by another is described the Sulc '367 patent.

An example method for installing an anchor, using implant anchor member 102 and angled support 104 of dental appliance anchoring apparatus 100, will be described. First, the installation site is prepared using established methods within the dental and oral surgery arts. Next, the bone is pre-drilled, using a drill bit diameter and drilling depth selected by one skilled in the relevant arts. Tapered end 110 of threaded shaft 106 of implant anchor member 102 is then placed into the drilled area and, using a wrench corresponding to gripping surface 116, implant anchor member 102 is screwed into the bone until lower surface 112 is at the desired height.

Next, using the alignment handle described as item 50 in the Sulc '181 patent, or by direct visual inspection, an appropriate THETA angle for the implant anchor member 102 is chosen. As described above, typical THETA angles are 0, 5, 11, and 17 degrees. Therefore, in a typical method according to this invention, the dentist or oral surgeon would have an assortment of angled support 104, having THETA angles such as the examples identified above.

A dental prosthesis such as that shown in Sulc '181 having a male extension is then placed over and engaged into upper angled female eyelet 118 as described above. As described in the Sulc '181 patent, a temporary cap, such as the item labeled as item “40” therein, may be installed into upper angled female eyelet 118 until a prosthesis becomes available.

The previous detailed description is of a small number of embodiments for implementing the dental appliance anchoring apparatus and is not intended to be limiting in scope. One of skill in this art will immediately envisage the methods and variations used to implement this invention in other areas than those described in detail. The following claims set forth a number of the embodiments of the dental appliance anchoring apparatus disclosed with greater particularity.

What is claimed:

1. A dental appliance anchoring apparatus, comprising:
an implant anchor member having a tapered threaded post for engagement with a bone and a female receptacle, the outside area of the female receptacle having gripping portions for engaging with a tightening device, the female receptacle having a lateral undercut reservoir for accepting an adhesive, wherein the threaded post includes threads that have a substantially flat top land; and
an angled support having a slotted tubular base and an upper angled female eyelet for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the implant anchor member, wherein the angled support is rotatable within the female receptacle for optimizing its position prior to being secured with the adhesive.

2. The dental appliance anchoring apparatus according to claim 1, wherein the upper angled female eyelet is formed by an outer sidewall that terminates radially inwardly towards the center of the upper angled female eyelet.

3. The dental appliance anchoring apparatus according to claim 1, wherein the upper angled female eyelet is formed by an inner sidewall that terminates radially outwardly towards the outer sidewall.

4. The dental appliance anchoring apparatus according to claim 1, wherein the upper angled female eyelet terminates distally in a curved annular edge.

5. The dental appliance anchoring apparatus according to claim 1, wherein the slotted tubular base comprises:
one or more slotted tubular sections forming a hollowed cylindrical area disposed therebetween.

6. The dental appliance anchoring apparatus according to claim 5, wherein the one or more slotted tubular sections comprises curved planar portions that extend distally in a longitudinal direction from the outer circumference of the angled support.

7. The dental appliance anchoring apparatus according to claim 1, wherein the implant anchor member is a unitary metal structure.

8. The dental appliance anchoring apparatus according to claim 1, further comprising:
a dental prosthesis having a male extension shaped for cooperative engagement with the upper angled female eyelet of the angled support, wherein the dental prosthesis is secured to the angled support by such cooperative engagement.

9. The dental appliance anchoring apparatus according to claim 1, wherein the slotted tubular base of the angled support is secured within the female receptacle of the implant anchor member by a combination of an interference fit in resilient engagement with the slotted lower circular base and the adhesive.

10. A dental appliance anchoring apparatus, comprising:
an elongated body for engagement with a bone, the elongate body having a female threaded receptacle;
a base having a male threaded portion and a female receptacle, the female receptacle having a lateral undercut reservoir for accepting an adhesive, wherein the male threaded portion threads into the female threaded receptacle; and
an angled support having a slotted tubular base and an upper angled female eyelet terminating distally in a curved annular end for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the base by the adhesive, and wherein the slotted tubular base of the angled support and the upper receptacle are constructed and arranged such that the lower base of the angled support rotates within the upper receptacle, about the first longitudinal axis, prior to being secured by the adhesive.

11. The dental appliance anchoring apparatus according to claim 10, wherein the curved annular end is formed by an outer sidewall that terminates radially inwardly towards the center of the upper angled female eyelet.

12. The dental appliance anchoring apparatus according to claim 10, wherein the curved annular end is formed by an inner sidewall that terminates radially outwardly towards the outer sidewall.

13. The dental appliance anchoring apparatus according to claim 10, wherein the slotted tubular base comprises:
one or more slotted tubular sections forming a hollowed cylindrical area disposed therebetween.

14. The dental appliance anchoring apparatus according to claim 13, wherein the one or more slotted tubular sections comprises curved planar portions that extend distally in a longitudinal direction from the outer circumference of the angled support.

15. The dental appliance anchoring apparatus according to claim 10, wherein the elongated body is a unitary metal structure.

16. The dental appliance anchoring apparatus according to claim 10, further comprising:
a dental prosthesis having a male extension shaped for cooperative engagement with the upper angled female eyelet of the angled support, wherein the dental prosthesis is secured to the angled support by such cooperative engagement.

17. The dental appliance anchoring apparatus according to claim 10, wherein the slotted tubular base has a wall thickness of from about 0.01 inches to about 0.03 inches.

18. The dental appliance anchoring apparatus according to claim 10, wherein the slotted tubular base comprises:
a longitudinal tube with four equally spaced longitudinal slots, the slots having a diameter of from about 0.011 inches to 0.015 inches.

19. The dental appliance anchoring apparatus according to claim 10, wherein the female receptacle further comprises:
a circumferential ridge.

20. The dental appliance anchoring apparatus according to claim 19, wherein the slotted tubular base further comprises:
a circumferential recess for engaging with the circumferential ridge of the female receptacle.

21. An angled dental support comprising:
a slotted tubular base for engaging a dental implant anchor; and
an upper angled female eyelet terminating distally in a curved annular end for engaging a dental prosthesis, the slotted tubular base having a first longitudinal axis and the upper angled female eyelet having a second longitudinal axis, the second longitudinal axis and the first longitudinal axis forming a mounting angle with respect to one another, wherein the slotted tubular base of the angled support is secured within the female receptacle of the implant anchor member by the adhesive, and wherein the slotted tubular base of the angled support and the upper receptacle are constructed and arranged such that the lower base of the angled support rotates within the upper receptacle, about the first longitudinal axis, prior to being secured by the adhesive.

22. The angled dental support according to claim 21, wherein the curved annular end forms a substantially rounded annular end.

23. The angled dental support according to claim 21, wherein the curved annular end is substantially rounded.

24. The angled dental support according to claim 21, wherein the slotted tubular base comprises:
one or more slotted tubular sections forming a hollowed cylindrical area disposed therebetween.

25. The angled dental support according to claim 24, wherein the one or more slotted tubular sections comprises curved planar portions that extend distally longitudinally from the outer circumference of the angled support.

26. The angled dental support according to claim 21, further comprising:
a dental prosthesis having a male extension shaped for cooperative engagement with the upper angled female eyelet of the angled dental support, wherein the dental prosthesis is secured to the angled support by such cooperative engagement.

27. The angled dental support according to claim 21, wherein the slotted tubular base comprises:
one or more slotted tubular sections forming a hollowed cylindrical area disposed therebetween.
